(19) United States
(12) Patent Application Publication
(10) Pub. No.: US 2014/0365405 A1
(43) Pub. Date: Dec. 11, 2014

(54) Context Aware Information Prediction

(71) Applicants: Yuan Zhu, Beijing (CN); Jiacheng Wang, Beijing (CN)

(72) Inventors: Yuan Zhu, Beijing (CN); Jiacheng Wang, Beijing (CN)

(21) Appl. No.: 13/991,654

(22) PCT Filed: Dec. 28, 2012
(86) PCT No.: PCT/CN2012/087837

§ 371 Date: Jun. 5, 2013

(51) Int. Cl. G06N 5/04; G06F 17/30; G06F 3/0481

(52) U.S. Cl. CPC G06N 5/04; G06F 3/0481; G06F 17/30873
USPC 706/11

(57) ABSTRACT

In some embodiments, instead of relying only on information about the characters that are being entered to predict what data is intended to be entered into a user interface, information about the user interface itself may be used to help predict what data may be entered. For example, attributes that are associated with a text entry box can be used to provide more accurate predictions of what data a user intends to enter.

### BACKGROUND

This relates generally to user interfaces that enable users to enter data into processor based devices.

Processor based devices receive a large variety of user input data. It is generally advantageous to save the user the trouble of entering the full text string to the greatest possible extent. Thus, systems are available which, based on the initial character entries, predict the complete user entry to save the user the trouble of typing in the entire entry. Automatic text completion is applicable to both mobile and non-mobile computers. However, because of the absence, in many cases, of a full keyboard with some mobile computers, automatic text completion tends to be even more important in the case of mobile computers with limited keyboard accessibility.

### BRIEF DESCRIPTION OF THE DRAWINGS

Features and advantages of embodiments of the present invention will become apparent from the appended claims, the following detailed description of one or more example embodiments, and the corresponding figures, in which:

FIG. 1 is a front elevational view of a processor based device according to one embodiment.

FIG. 2 is a depiction of a text entry box with a dropdown menu according to one embodiment.

FIG. 3 is a depiction of a table useful in correlating text entry box attributes to possible data entry predictions.

FIG. 4 is a schematic depiction of one embodiment.

FIG. 5 is a flow chart for a sequence according to one embodiment.

FIG. 6 is a system depiction for one embodiment.

### DETAILED DESCRIPTION

In some embodiments, instead of relying only on information about the initial characters that are being entered to predict what data is intended to be entered into a user interface, information about the user interface itself may be used to help predict what data may be entered. For example, attributes that are associated with a text entry box can be used to provide more accurate predictions of what data a user intends to enter.

Typical user interfaces take the initial characters (letters, symbols or numbers) that have been entered and, based on information about the most commonly entered data, either by that user or by users in general, predict what information is going to be entered. Then the text entry may be automatically completed based on the successful prediction.

By taking into account the nature of a text entry interface, such as the text entry box, a more useful prediction may be obtained in some cases. As an example, when a text entry box is associated with a phone book search window, it may be predicted that instead of simply entering any word, the user is actually entering a name. In such case, instead of offering predictions based on most commonly used words, predictions based on most common name may be generated. For example, a list of the most commonly used names associated with the character(s) already entered may appear on the screen for selection by the user. The selected names may be followed with the conventionally generated words or names based on other criteria in some embodiments. By using information about the text entry box and, particularly, its attributes, more accurate predictions about what the user is trying to enter may be obtained in some embodiments.

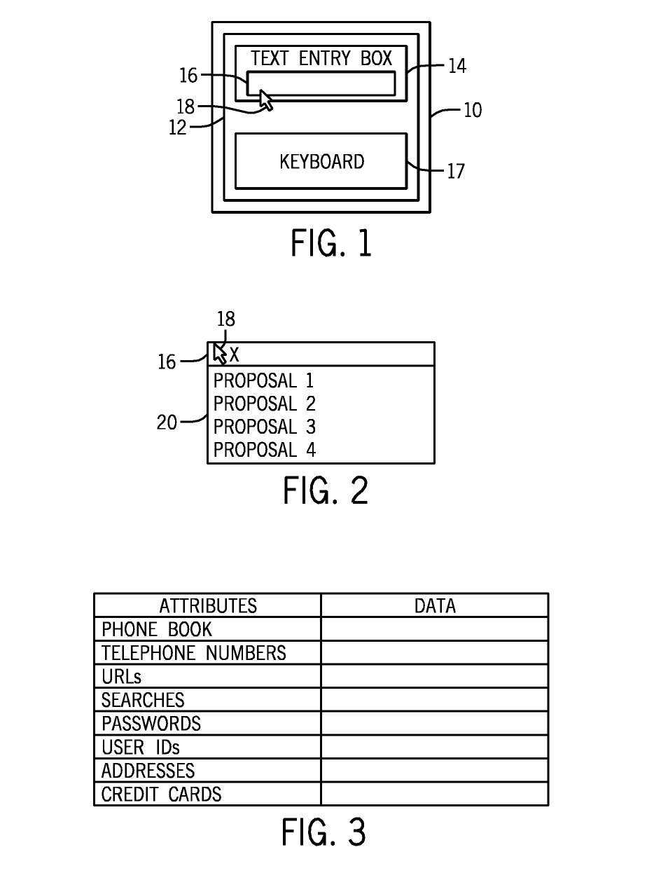

Referring to FIG. 1, a processor based system 10 may be a mobile device, such as a laptop computer, a mobile Internet device, an e-book reader, a cellular telephone, or a tablet computer. In some embodiments, it may not include a keyboard and, instead, may use an on-screen or virtual keyboard. However, embodiments are applicable to any type of processor based device, including personal computers.

In FIG. 1, a display 12 may display a text entry area, such as a text entry box 14, with a text entry area 16. In one embodiment, the display may be a touch screen, but other displays may also be used. Since the user has selected the text entry area 16, a cursor 18 may appear in the text entry area 16. In response to the selection of a text entry area, a virtual keyboard display 17 may appear. Thus, the keyboard may be a graphical overlay over whatever else is depicted. It may include depictions of characters, such as numbers, letters, or symbols.

Referring to FIG. 2, when the user begins to enter the first character (indicated as X in this case) in the text entry area 16, a set of text entry completion proposals may be generated which are system developed predictions of the word, phrase, number, or whatever that the user may be starting to enter. The idea is to save the user the trouble of typing out the entire entry. This is particularly valuable in embodiments with limited or virtual keyboards.

Thus, a set of user selectable proposals may be generated in a dropdown menu 20, in one embodiment. Of course, other graphical user interfaces may also be used in addition to the depicted dropdown menu 20. Each of the proposals may be a word, a name, or a number that is predicted based on the information that has already been entered. In accordance with some embodiments, the prediction may be further honed by using information about the nature of the text entry box 16 to predict what information is being entered. In such case, the proposed predictions of the user's intended entry that correlate both to being commonly used with the characters entered and which are commonly used in association with text entry boxes with those attributes are ordered first, followed by conventionally generated proposals, in some embodiments.

In other embodiments, only the text entry box attribute inspired entries may be shown and other ordering sequences and display arrangements may be used. For example, initially, only the text entry attribute inspired proposals are shown with an icon that can be selected for displaying more proposals, based on non-text entry inspired techniques that are conventionally used.

The proposals may be user click selectable, in some embodiments. When clicked on, the full entry may be automatically inserted in the text entry box. In other embodiments, the first proposal may be used automatically, absent user override.

Thus, referring to FIG. 3, the processor based device 10 may store a table of the type depicted in FIG. 3. The table may include a tuple including an attribute and the most likely data generally entered with that attribute. Thus, for a phonebook text entry attribute, if the user enters the letter A, the most commonly used names beginning with the letter A may be generated. Similarly, in a telephone number text entry attribute case, telephone numbers would be searched based on the character or characters that have been entered. Other embodiments could include universal resource locators, search text entry boxes, password text entry boxes, user identifier text entry boxes, address text entry boxes, and credit card text entry boxes, as examples.

In each case, the attribute is associated with words, numbers, or other characters that are commonly entered in text entry boxes having that attribute. These lists may be generated locally within the processor based device based on the user's own activities, or may be obtained from remote sources based on activities of a wide variety of users, predictions about what a wide variety of users may use or may be some combination of the above.

The manner of extracting the attributes from the text entry box is subject to wide variation. For example, conventional hypertext markup language (HTML) includes code in the markup language characters for the text entry box that can be used to generate the text entry box and, therefore, indicates the nature of the text entry box. This code, in one embodiment, may be used to correlate to attributes which, in turn, are correlated to proposed entries that are most common in cases involving such attributes.

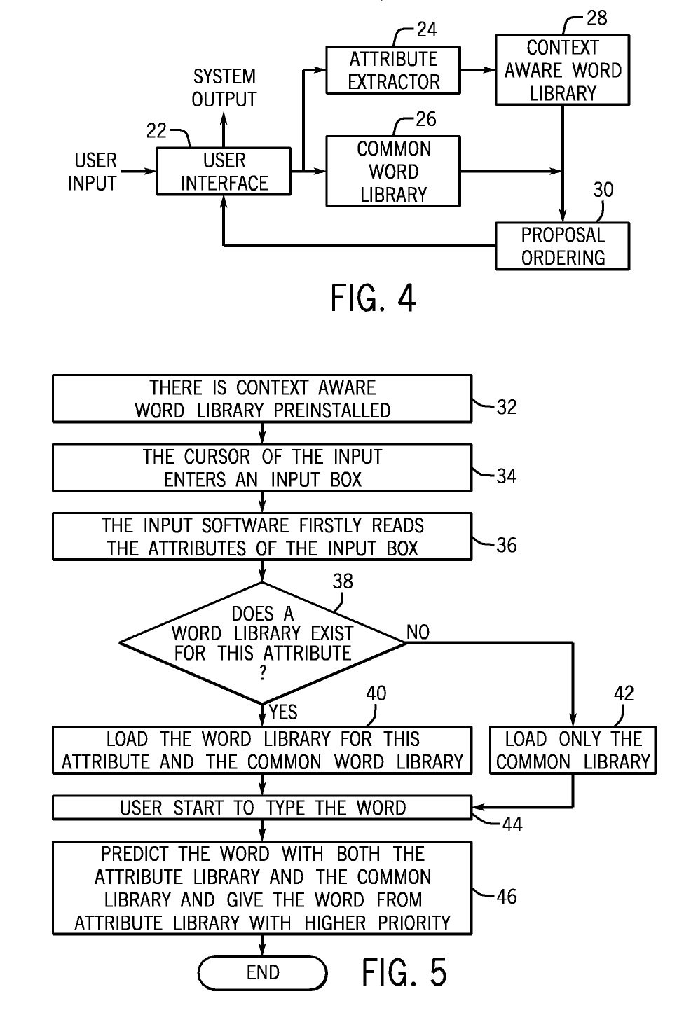

Referring to FIG. 4, in accordance with some embodiments, a user interface 22, such as a touch screen display, may receive user inputs and may provide user outputs for display. For example, the user interface may be a touch screen with a virtual keyboard that can display upon request text entry boxes. When the user makes a user input in association with a text entry box, that input may be provided to an attribute extractor 24. The attribute extractor 24 extracts an attribute of the text entry box itself and uses that attribute to search a context aware word library 28. For example, the HTML string may be parsed to extract code for producing the text entry box. That code indicates the nature of the text entry box from which an attribute of the text entry box may be derived. The context aware word library may, in one embodiment, include a table, such as that shown in FIG. 3, that correlates attributes to commonly entered words, numbers, or characters. Then, based on the text entry that has been received so far, the most likely candidates may be chosen.

At the same time, the entry provided to the user interface 22 may be used as a search term in a common word library 26. The common word library may simply include the most common entries by that particular user on that particular processor based device and/or those most common entries derived based on experience across any number of users and provided either locally or by accessing a remote resource, such as a remote server or the cloud.

The output from the common word library 26 is then combined with the output from the context word library 28 and provided to an ordering module 30. The ordering module may determine the way in which the various proposals are displayed and ordered. This ordering is then provided to the user interface 22 for output on the display. In some embodiments, the output may be provided as a dropdown menu below the text entry box.

Referring next to FIG. 5, the sequence depicted there may be implemented in software, firmware, and/or hardware. In software and firmware embodiments, it may implemented as computer executed instructions stored in a computer readable medium. In some embodiments, the computer readable medium may be a non-transitory computer readable medium, such as a magnetic, optical, or semiconductor storage.

Program code, or instructions, may be stored in, for example, volatile and/or non-volatile memory, such as storage devices and/or an associated machine readable or machine accessible medium including, but not limited to, solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a medium through which the program code may pass, such as antennas, optical fibers, communications interfaces, etc. Program code may be transmitted in the form of packets, serial data, parallel data, etc., and may be used in a compressed or encrypted format.

The sequence of FIG. 5 begins by determining that there is a context word library preinstalled (block 32). Then the cursor is placed by the user an input or text entry box, as indicated in block 34. Next, the input software reads an attribute of the input or text entry box, as indicated in block 36.

A check at diamond 38 determines whether a word library exists for that attribute. If so, the word library for the attribute and the common word library are loaded, as indicated in block 40. If not, only the common word library is loaded, as indicated in block 42.

When the user starts to type an entry, as indicated in block 44, the word or string that is probably being typed is predicted using both the attribute library and the common library, as indicated in block 46. The word or string from the attribute library may be given higher priority in some embodiments.

Portable electronic devices may include predictive capabilities to decrease the device user's typing requirements. This feature is especially useful in portable electronic devices such as tablet computers and mobile phones, which may not include a physical keyboard. Rather, some portable electronic devices may have a simulated or virtual keyboard. The size of such keyboards is typically limited by the size of the display screen, which may make typing difficult and error-prone.

According to an embodiment, a portable electronic device may include enhanced predictive capabilities, which may focus predictions presented to a device user. For example, in an embodiment, the portable electronic device may use an active entry (e.g., one or more letters, numbers, symbols) and contextual information (e.g., information type) to provide one or more targeted predictions (e.g., word, number, character, phrase, symbol) as is appropriate under the particular circumstances. In an embodiment, the active entry may be one or more letters of the Latin alphabet and the targeted prediction(s) may be in a non-Latin writing system (e.g., Chinese, Devanagari, Arabic, Cyrillic), or the Romanized (e.g., pinyin) version of the non-Latin writing system.

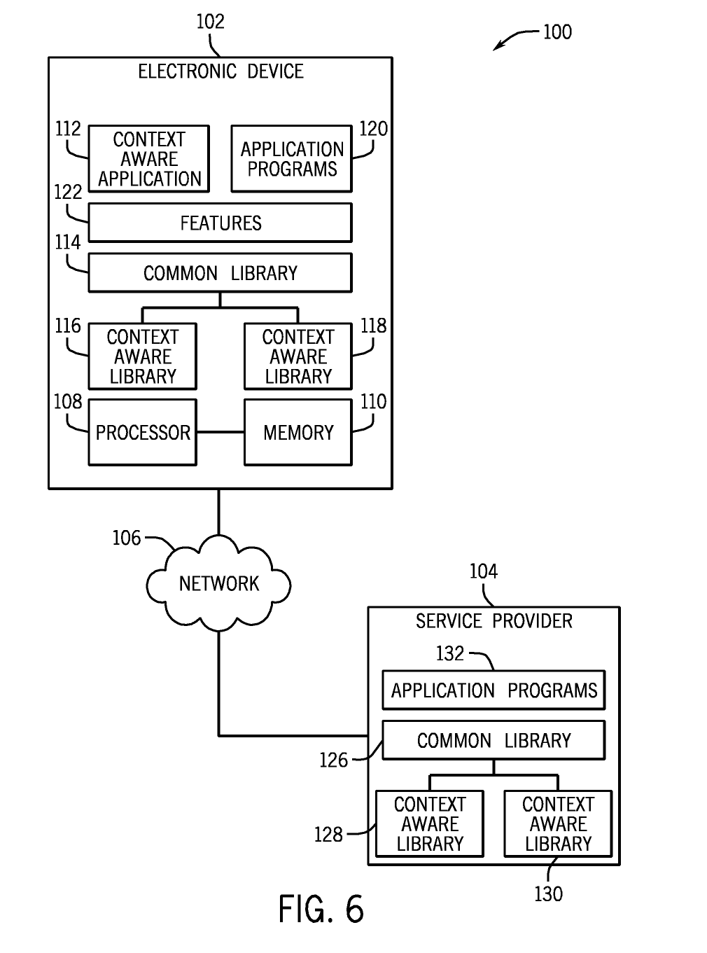

Referring to FIG. 6, a system 100 is shown that may be used to implement one embodiment. The system 100 may include one or both of an electronic device 102 and a service provider 104. The electronic device 102 may correspond to the device 10 of FIG. 1. The system 100 may also include a network 106, which may couple the electronic device 102 and the service provider 104. The electronic device 102 may be a portable or mobile electronic device such as, without limitation, a mobile phone (e.g., smartphone), a tablet computer, a notebook computer, or a personal digital assistant. In an embodiment, the service provider 104 may provide communications, storage, processing, or content services, or combinations thereof. Such services may be provided via a common carrier, an Internet service provider (ISP), or other Web- or cloud-based service, and combinations thereof. The network 106 may be a wired network, a wireless network, or combinations of various wired and wireless networks. Exemplary networks include telephone networks (e.g., cellular networks, wireless wide area networks), an internet (e.g., global Internet), wireless local area networks (e.g., Wi-Fi), wide area networks (WAN), and local area networks (LAN).

Still referring to FIG. 6, the electronic device 102 may include a mobile platform, which may include at least one processor 108 and a memory 110 coupled to the processor 108. In an embodiment, the processor 108 and the memory 110 may be contained on a single chip (e.g., system-on-chip), although embodiments are not limited thereto. The electronic device 102 may include a context-aware prediction application 112 and one or more libraries 114, 116, and 118. In an embodiment, the libraries 114, 116, and 118 may be hierarchical, with a common word library 114 at the top of the hierarchy and context-aware libraries 116 and 118 at a level below the common library 114. Although not shown, context-aware libraries 116 and 118 may be further subdivided into sub-context-aware libraries and so on. The one or more libraries 114, 116, and 118 are not required to have a hierarchical structure; rather, they may have any suitable structure, and in some cases may even lack structure (e.g., free-form).

The electronic device 102 may also include plural additional application programs 120 and features 122. For example, the device 102 may come with plural application programs 120 such as an application for storing contact information, web browsing, calendaring, and the user may download or access (e.g., from the service provider 104) a wide variety of application programs such as for identifying music, time management, games, and social networking to name just a few examples. Application programs 120 may be stored on the electronic device 102, by the service provider 104 (e.g., cloud storage), or both. The device 102 may also include one or more features 122 such as, a global positioning system (GPS), a music player, a camera, and a touch screen), as just a few examples.

A user of the electronic device 102 may interact with application programs and device features via a user interface. In an embodiment, the user interface may include a graphical user interface (GUI) displayed on a display screen 112, which may be a touch screen. User interfaces for devices including a touch screen may be designed in numerous ways. As one non-limiting example, user interfaces may be designed to include a simulated keypad and/or a keyboard 114 (e.g., virtual a keypad/keyboard) and a data entry area 116 to receive information from the user. The user interface may also include a context indicator 118, which may or may not be visible to the user. The context indicator 118 may be associated with a particular application, information entry area, or both. Context indicators 118, however, may be obtained by other means such as via electronic device 102 sensors (e.g., global positioning systems, accelerometers, video), data mining techniques, recently used apps (e.g., calendar, e-book reader), or other features (e.g., music player, voice/calling services).

As one example, the user may want to enter a new contact into a phone book or contact list application program. An interface including a text entry box or the like may be provided to enable the user to enter a person's name. The text entry box may be associated with an attribute, tag, marker, descriptor, or other context indicator to specify that the box receives a name as input data.

The following clauses and/or examples pertain to further embodiments:

One example embodiment may be at least one machine accessible storage medium having instructions stored therein, the instructions when executed on a machine cause the machine to perform a sequence comprising: receiving a user partial text entry in a text entry area, determining an attribute of the text entry area, and using said attribute and the partial text entry to develop a prediction of what a user intends to enter into that text entry area. The medium may further store instructions to perform a sequence including developing a series of user selectable proposed intended text entries. The medium may further store instructions to perform a sequence including developing a series of user selectable proposed intended text entries based on said attribute. The medium may further store instructions to perform a sequence including developing a series of user selectable proposed intended text entries based on common entries. The medium may further store instructions to perform a sequence including ordering the series based on the attribute before the series based on common entries. The medium may further store instructions to perform a sequence including identifying a text entry area as being associated with numbers and proposing completions that are numbers. The medium may further store instructions to perform a sequence including identifying a text entry area as being associated with web pages and proposing completion that are web page locations.

In another example embodiment a computer executed method comprising receiving, on a processor based device, a user partial text entry in a text entry area, and using said attribute and the partial text entry to develop a prediction of what a user intends to enter into that text entry area. The method may include developing a series of user selectable proposed intended text entries. The method may include developing a series of user selectable proposed intended text entries based on said attribute. The method may include developing a series of user selectable proposed intended text entries based on common entries. The method may include ordering the series based on the attribute before the series based on common entries. The method may include identifying a text entry area as being associated with numbers and proposing completions that are numbers. The method may include identifying a text entry area as being associated with web pages and proposing completion that are web page locations.

Another example embodiment may be a processor based device comprising a processor to receive a user partial text entry in a text entry area, determine an attribute of the text entry area, and use said attribute and said partial text entry to develop a prediction of what a user intends to enter into that text entry area, and a memory coupled to said processor. The device may include said processor to develop a series of user selectable proposed intended text entries. The device may also include said processor to develop a series of user selectable proposed intended text entries based on said attribute. The device may also include said processor to develop a series of user selectable proposed intended text entries based on common entries. The device may also include said processor to order the series based on the attribute before the series based on common entries. The device may also include said processor to identify a text entry area as being associated with names and proposing completions based on names.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. At least one machine accessible storage medium having instructions stored therein, the instructions when executed on a machine cause the machine to perform a sequence comprising:
receiving a user partial text entry in a text entry area;
determining an attribute of the text entry area; and
using said attribute and the partial text entry to develop a prediction of what a user intends to enter into that text entry area.

2. The medium of claim 1 further storing instructions to perform a sequence including developing a series of user selectable proposed intended text entries.

3. The medium of claim 1 further storing instructions to perform a sequence including developing a series of user selectable proposed intended text entries based on said attribute.

4. The medium of claim 3 further storing instructions to perform a sequence including developing a series of user selectable proposed intended text entries based on common entries.

5. The medium of claim 4 further storing instructions to perform a sequence including ordering the series based on the attribute before the series based on common entries.

6. The medium of claim 1 further storing instructions to perform a sequence including identifying a text entry area as being associated with names and proposing completions based on names.

7. The medium of claim 1 further storing instructions to perform a sequence including identifying a text entry area as being associated with numbers and proposing completions that are numbers.

8. The medium of claim 1 further storing instructions to perform a sequence including identifying a text entry area as being associated with web pages and proposing completion that are web page locations.

9. A computer executed method comprising:
receiving, on a processor based device, a user partial text entry in a text entry area;
determining an attribute of the text entry area; and
using said attribute and the partial text entry to develop a prediction of what a user intends to enter into that text entry area.

10. The method of claim 9 including developing a series of user selectable proposed intended text entries.

11. The method of claim 9 including developing a series of user selectable proposed intended text entries based on said attribute.

12. The method of claim 11 including developing a series of user selectable proposed intended text entries based on common entries.

13. The method of claim 12 including ordering the series based on the attribute before the series based on common entries.

14. The method of claim 9 including identifying a text entry area as being associated with names and proposing completions based on names.

15. The method of claim 9 including identifying a text entry area as being associated with numbers and proposing completions that are numbers.

16. The method of claim 9 including identifying a text entry area as being associated with web pages and proposing completion that are web page locations.

17. A processor based device comprising:
a processor to receive a user partial text entry in a text entry area, determine an attribute of the text entry area, and use said attribute and said partial text entry to develop a prediction of what a user intends to enter into that text entry area; and
a memory coupled to said processor.

18. The device of claim 17, said processor to develop a series of user selectable proposed intended text entries.

19. The device of claim 17, said processor to develop a series of user selectable proposed intended text entries based on said attribute.

20. The device of claim 19, said processor to develop a series of user selectable proposed intended text entries based on common entries.

21. The device of claim 20, said processor to order the series based on the attribute before the series based on common entries.

22. The device of claim 17, said processor to identify a text entry area as being associated with names and proposing completions based on names.

23. The device of claim 17, said processor to identify a text entry area as being associated with numbers and proposing completions that are numbers.

24. The device of claim 17 wherein said device is a cellular telephone.

25. At least one machine accessible storage medium having instructions stored therein, the instructions when executed on a machine cause the machine to perform a sequence comprising:
receiving user partial text entry in a text entry area;
parsing a hypertext string to identify code for creating said text entry area; and
using said code and said partial text entry to predict what a user intends to enter into that text entry area.

26. The medium of claim 25 further storing instructions to perform a sequence including developing a series of user selectable proposed intended text entries.

27. The medium of claim 25 further storing instructions to perform a sequence including developing a series of user selectable proposed intended text entries based on said code.

28. The medium of claim 27 further storing instructions to perform a sequence including developing a series of user selectable proposed intended text entries based on common entries.

29. The medium of claim 28 further storing instructions to perform a sequence including ordering the series based on the code before the series based on common entries.

30. The medium of claim 25 further storing instructions to perform a sequence including identifying a text entry area as being associated with names and proposing completions based on names.
